(19) United States
(12) Patent Application Publication
(10) Pub. No.: US 2011/0071976 A1
(43) Pub. Date: Mar. 24, 2011

(54) RETAIL AUTOMOTIVE AFTERMARKET PARTS ASSORTMENT PLANNING

(75) Inventor: Scott Raymond MUTCHLER, Grayslake, VA (US)

(73) Assignee: Advance Auto Innovations, LLC, Roanoke, VA (US)

(21) Appl. No.: 12/566,542

(22) Filed: Sep. 24, 2009

(51) Int. Cl. G06N 5/02; G06Q 10/00

(52) U.S. Cl. 706/48; 705/29

(57) ABSTRACT

Identifying parts for an assortment. Receiving data characterizing: storage capacity by part category, parts in the category, rules applicable to the category. Assembling rule sets requiring compliance with each rule for a part to be a rule set group member. Receiving data prioritizing rule sets. Beginning with highest priority rule set, proceeding by order of rule set priority, determining if each part is rule set group member. For parts not a member of the rule set group, determining if each of those parts is a member of the next highest priority rule set group. Receiving data for prioritizing parts in a rule set group. Allocating parts to the assortment beginning with the highest prioritized part in the highest prioritized rule set group, and continuing in order of part priority within a rule set group, then continuing through subsequently prioritized rule set groups until inventory storage capacity is reached.

### FIELD OF THE TECHNOLOGY

The technology disclosed herein relates to systems and methods for selecting automotive parts and products for inclusion in the on-site inventory (e.g., assortment) of a brick-and-mortar auto parts retail store.

### BACKGROUND

The aftermarket automotive parts retail environment presents a number of unique assortment planning challenges when compared to traditional retail environments. Customers have a relatively high expectation of having immediate, e.g., in-store, availability for the parts for their specific vehicle. For many part categories, e.g., brake pads, alternators, the customer simply will not wait for the part (even a few hours) to be delivered from further up the supply chain.

### SUMMARY

The technology includes systems, methods, and computer program products for identifying parts in a part category for a future store-specific assortment. The technology includes receiving data characterizing parts inventory storage capacity of a store for a part category for a future period, data characterizing a plurality of parts in the part category, and rules applicable to the part category. A plurality of rule sets are assembled. Each rule set includes at least one received rule, and requires compliance with each rule in the rule set for a part to be a member of the rule set group. Data prioritizing the assembled rule sets is received. Then beginning with the highest priority rule set as the current rule set, and proceeding by order of rule set priority, the technology determines if each of the plurality of parts in the parts category is a member of the current rule set group. For each of the plurality of parts in the parts category that is not a member of the current rule set group (i.e., remaining parts), the technology determines if each of the remaining parts is a member of the next highest priority rule set group. For each rule set group, data for prioritizing parts in a rule set group is received. Parts are allocated to the assortment beginning with the highest prioritized part in the highest prioritized rule set group, and continuing in order of part priority within a rule set group, then continuing through subsequently prioritized rule set groups by part priority within the subsequently prioritized rule set group, until the inventory storage capacity is reached.

### BRIEF DESCRIPTION OF THE DRAWINGS

FIG. 1 illustrates a method of the present technology.

### DETAILED DESCRIPTION

Reference will now be made in detail to embodiments of the technology. Each example is provided by way of explanation of the technology only, not as a limitation of the technology. It will be apparent to those skilled in the art that various modifications and variations can be made in the present technology without departing from the scope or spirit of the technology. For instance, features described as part of one embodiment can be used on another embodiment to yield a still further embodiment. Thus, it is intended that the present technology cover such modifications and variations that come within the scope of the technology.

The demand for automotive aftermarket parts is based on, in substantial part, i) the vehicle population of a store's trade area, and ii) part failure rates. Most trade area vehicle populations can be characterized by a long tail distribution. That is most vehicles in a store trade area are the popular makes and models, but there is a long tail of less popular vehicles that in aggregate are a significant percent of the total vehicle population. To provide coverage for this large vehicle population lying in the tail of the vehicle population distribution requires a significant investment in low demand inventory.

Long tail retailers such as Amazon.com have the luxury of having a cloud of inventory housed across many warehouses. They are able to fill fringe product requests because they have the time to fill the order over a few days from multiple, typically geographically dispersed warehouses. However, the aftermarket automotive parts retail sites are typically confined to traditional brick and motor stores that can contain only a very small fraction of the national assortment that is available to an individual store only with some latency. While the entire assortment is available within the supply chain (often within a few hours), many customers will not wait that long for delivery.

Given the customer's high expectation of part availability and the long tail (vehicle population-specific) demand within each store's trade area, the aftermarket automotive parts industry is forced to carry as much inventory as possible within each store with the majority of the inventory servicing the long tail (i.e. low demand/vehicle-specific parts). Assortment accuracy, e.g., matching the assortment to the demand, within each store is of concern to store owners given the large cost of carrying a broad store inventory. However, determining which parts within the long tail to carry has proven to be a challenging task due to the fact the demand is very weak, e.g., a store may only sell one of a long tail part within a year.

In addition to the influence that long tail demand based on local vehicle populations and part failure rates has on the selection of in-store part assortments, some stores have commercial customers (such as commercial garages, etc.) that influence demand. Commercial customers may alter the demand for specific parts relative to traditional Do It Yourself (DIY) customers. For example, a store may be adjacent to an import car repair shop and may have additional demand for foreign parts.

The present technology leverages the knowledge of product merchants while facilitating a rational and scalable process for identifying parts for a store assortment. The present technology includes creating rules and rule sets, and turning merchant knowledge, e.g., the relative importance of each set of rules, into computer-executable rule sets. The rule sets are used, to prioritize parts for inclusion in a store assortment. These rule sets can include rules based on predictive model output.

In addition to creating and prioritizing rule sets using merchant knowledge, rule sets can be ordered by their effectiveness, e.g., as measured against historical sales. The more effective rule sets are ordered earlier in the list of rule sets. Rule sets are applied in order of priority to each candidate part, e.g., Wagner Brake Pads/Shoes—Front Part No. MX912, in a part category, e.g., brake pads. Each candidate part in the part category is classified into the first rule set group for which it meets all the rules in the rule set. For example, 20% of parts may fall into the first rule set group. These 20% of parts would be the best candidate parts to be added to the store and would be added first, given space constraints on the part category. Within each rule set group the parts are ordered in such a way that the best parts are at the top of the group and are added to assortments first.

Rule sets can be composed of a number of rules, each rule having a binary outcome, e.g., Part A either meets the all the criteria called for in the rule set or it doesn't. The individual rules can include configurable parameters.

Here is an example of a rule set that defines a rule set grouping of parts. Terms bracketed by “< >” are configurable parameters. The first three are merchant rules, the remaining come from predictive models.
The part has sold at least <once> in the store in the previous <year>.
The part has sold on average in at least <1> out of the <4> stores in this store's cluster (the store cluster contains similar stores to the target store).
The part has been flagged as having at least <1> lost sale in the prior year (as measured by the store point of sale system).
The part is predicted to sell in this store over the next allocation period given predictive model output (e.g. logistic regression model).
The part is predicted to have strong growth next year (across the company) using forecasting model output.
The part fits at least <100> vehicles registered in the store's trade area.

If this rule set was identified as the highest priority rule set from among several rule sets, parts that comply with each rule in this rule set can be the first parts added to a store assortment. Within the group of parts that comply with each rule in this set, parts can be prioritized base on historic and predicted statistics, e.g., lost sales per store, cluster sales. The rule set is composed of merchant rules (using sales and lost sales) and predictive model rules (logistic regression and forecasting models). Threshold values for sales, lost sales, cluster sales, etc. can be configured by part category.

Rule sets can be composed of any number of rules based on, e.g., historical sales, historical lost sales, vehicle populations, forecasted growth (part life cycle), sales predictions (e.g. logistic regression models), etc. The order in which the rule sets are applied can initially be determined by merchant knowledge, and as more empirical data is collected by measuring performance of sales of each rule set group.

The assortment planning process begins with merchants and merchandising scientist assembling rules and forming rule sets, e.g., sets of rules that require compliance by a part in order for the part to be considered a member of the rule set group of parts in that part category. Each rule can include configurable parameters, e.g., quantity, date (including range), geographic scope, etc. Each rule set can be given a relative priority (e.g., order the rule sets). For those rules with configurable parameters, configurable parameter values for each rule for each category can be established. Configuring rule parameters can be performed before or after choosing rules for a rule set and prioritizing rule sets. This data can be configured in a set of tables.

The technology can determine the available space for adding additional parts to the existing store inventories by removing unproductive inventory (no sales within a predefined period) for each category. In some embodiments, the available space is provided from another application. The technology can classify each candidate part (not already in the store's assortment) into a rule set group, starting with determining if the candidate part complies with each rule in the highest priority rule set for parts of that category. In some embodiments, once a part complies with the rules of a rule set, it is not considered for compliance with lower priority rule sets. Within a group of parts that complies with a rule set, i.e., the “rule set group” of parts for that rule set, parts can be prioritized based on predetermined criteria as mentioned above, e.g., by lost sales, by cluster sales.

Starting with the rule set group for the highest priority rule set, proceeding in priority order through parts in the rule set group, the technology can then add the best candidate parts to the assortment for the store under consideration until the space allocated for that part category is filled. Space allocation for a particular part category can be adjusted (both up and down) based on factors including number of parts falling in one or more higher priority rule set groups, management intent regarding growth of a space allocated to a category, and minimum allocation size for a category.

The final result can be a store-specific assortment. The parts added to the assortment would be those considered most likely to sell in that specific store based on the selected rules, rule sets, and configurable parameters, which in combination can reflect merchant knowledge, historical sales, historical lost sales, projected growth (part life cycle), and predictive model input, etc.

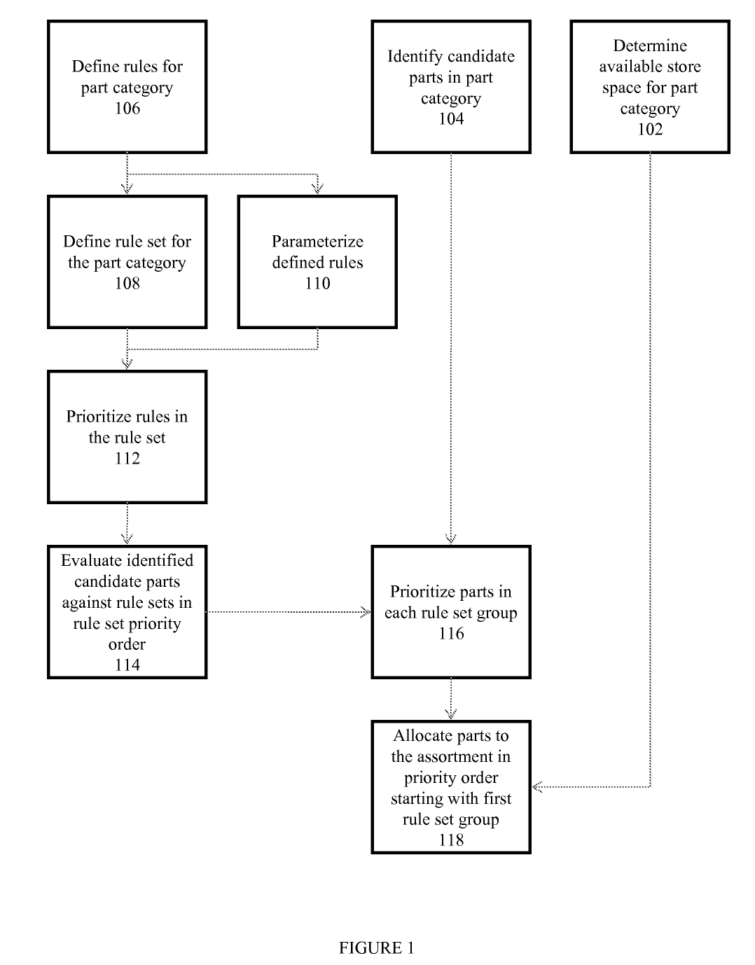

Referring to FIG. 1, an example will demonstrate the application of the invention to a single store and single category (i.e. brake pads). The current inventory for brake pads in a store is known and the store capacity for brake pads is known, allowing determination of space for additional brake pads 102. In this example, the store has space for three (3) additional brake pads (e.g., part numbers in the part category “brake pads”). The number of candidate parts is determined 104, e.g., there are five (5) candidate brake pads that can be added.

A list of rules for the category brake pads, e.g., from among a library of rules, is defined 106 as shown in TABLE 1. Sales, lost sales, cluster sales, and similar data each can be characterized as “sales data.” Available rules can include rules from merchants, rules based on predictive analytics, or a combination of each. Each rule is evaluated for each candidate part in the part category at the specific store being assorted. A rule can be defined, yet not included in the evaluation for a specific category. The numbers in brackets “< >” are configurable parameters that may differ by part category.

TABLE 1

| Rule | Rule Description |
|---|---|
| Sales | The brake pad must have sold at least <1> unit in |
| | the store in the prior year. |
| Lost Sales | The brake pad must have at least <1> lost sale in |
| | y the prior ear. |
| Cluster Sales | The brake pad must have sold in at least <1> out |
| | of <4> stores in this stores cluster. |
| Vehicle Registrations | The brake pad must fit at least <50> vehicles in |
| | this store's trade area. |
| Sales Prediction | The brake pad must be predicted to make at least |
| | <1> sale next year using predictive models. |
| Forecasted Growth | The brake pad must be projected to have |
| | companywide sales growth >= <5>% using |
| | forecasting models. |

Rule sets can be created 108 based on the binary outcomes of the rules as applied to each candidate part in the category. Initially, this can be done using merchant knowledge, and can be adjusted given actual sales performance post re-assortment. In the example, those rules with configurable parameters are parameterized 110 before prioritizing the rule sets. The rule sets are prioritized 112, e.g., from highest to lowest sales potential, with rule set 1 being this highest priority. For a part to be assigned to rule priority 1, all of the rules would have to be met by the candidate part in the given store. For a part to be assigned to rule priority 2, all of the rules minus lost sales would have to be met. TABLE 2 shows three rule sets in priority order, along with the rules that must result in a positive outcome for a part to be considered in the rule set group.

TABLE 2

| | Rules | | | | | |
|---|---|---|---|---|---|---|
| | | | | Vehicle | Sales | |
| | | Lost | Cluster | Regis- | Pre- | Forecasted |
| Rule Set # | Sales | Sales | Sales | trations | diction | Growth |
| 1 | Y | Y | Y | Y | Y | Y |
| 2 | Y | | Y | Y | Y | Y |
| 3 | | Y | Y | Y | | |

The five (5) candidate brake pads are evaluated 114 under rule sets 1, 2, and 3 in rule set order. The technology determines which, if any, rule set they belong in. Historical data for each of the parts is given in TABLE 3.

TABLE 3

| | | | Cluster Sales | Vehicle | Sales | |
|---|---|---|---|---|---|---|
| | | Lost | (# sales/ | Regis- | Pre- | Forecasted |
| Part # | Sales | Sales | #stores) | trations | diction | Growth (%) |
| 1000 | 3 | 0 | 0.8 | 85 | 2 | 6 |
| 1001 | 5 | 1 | 0.9 | 100 | 3 | 5 |
| 1002 | 0 | 3 | 0.75 | 90 | 1 | 0 |
| 1003 | 5 | 5 | 0.25 | 100 | 8 | 6 |
| 1004 | 1 | 2 | 09 | 100 | 1 | 7 |

Given these values for sales, etc. the parts would match the rule sets as shown in TABLE 3.

TABLE 3

| | | | | | Vehicle | Sales | |
|---|---|---|---|---|---|---|---|
| Matching | | | Lost | Cluster | Regis- | Pre- | Forecasted |
| Rule Set # | Part # | Sales | Sales | Sales | trations | diction | Growth |
| 2 | 1000 | Y | | Y | Y | Y | Y |
| 1 | 1001 | Y | Y | Y | Y | Y | Y |
| No match | 1002 | | Y | Y | Y | Y | |
| 1 | 1003 | Y | Y | Y | Y | Y | Y |
| 1 | 1004 | Y | Y | Y | Y | Y | Y |

From this analysis three parts are in the top potential rule set (set 1), one part in the second rule set and one SKU that is ignored (i.e. cannot be categorized). Given that the store has room for three parts in this part category, parts 1001, 1003, and 1004 can be added to the assortment 118. If the store has space for only two SKUs, the parts in rule set 1 can be ordered 116 using a static ordering (e.g., lost sales and cluster sales) such that part 1001 (with only one lost sale versus five lost sales for 1003 and two lost sales for 1004) would not be added to the assortment.

Each category in the store is competing for space based on the rule set priority. If a category such as brake pads has many Rule Set #1 matches, space allocated to that part category can expand within pre-defined limits 120, while other categories, e.g., categories with less parts matching higher priority rule sets for that category, can contract. Rules for expansion can be a function of factors such a profitability/store space.

The particular order illustrated in the preceding example is exemplary and not required, for example, individual rules can be parameterized after forming rule sets, reallocation of store space for any particular category is optional.

The technology can be implemented in the PL/SQL language. The database can be an Oracle 10.2 g Enterprise system with use of parallel execution and partitioning. The technology can take the form of hardware, software or both hardware and software elements. In some embodiments, the technology is implemented in software, which includes but is not limited to firmware, resident software, microcode, an FPGA or ASIC, etc. In particular, for real-time or near real-time use as in a patient position monitor, an FPGA or ASIC implementation is desirable.

Furthermore, assortment planning systems can, at least in part, take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

A data processing system suitable for storing a computer program product of the present technology and for executing the program code of the computer program product will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters can also be coupled to the system to enable the data processing system to become coupled to other data processing systems or remote printers or storage devices through intervening private or public networks. Modems, cable modem and Ethernet cards are just a few of the currently available types of network adapters.

1. A computer-implemented method for identifying parts in a part category for a future store-specific assortment, the method comprising:
in a data processing system,
receiving data characterizing parts inventory storage capacity of a store for a part category for a future period;
receiving data characterizing a plurality of parts in the part category;
receiving a plurality of rules applicable to the part category;
assembling a plurality of rule sets, each rule set:
comprising at least one received rule, and
requiring compliance with each rule in the rule set for a part to be a member of the rule set group,
receiving data prioritizing the assembled rule sets;
beginning with the highest priority rule set as the current rule set, and proceeding by order of rule set priority,
determining if each of the plurality of parts in the parts category is a member of the current rule set group;
for each of the plurality of parts in the parts category that is not a member of the current rule set group (i.e., remaining parts), determining if each of the remaining parts is a member of the next highest priority rule set group;
for each rule set group, receiving data for prioritizing parts in a rule set group;
allocating parts to the assortment beginning with the highest prioritized part in the highest prioritized rule set group, and continuing in order of part priority within a rule set group, then continuing through subsequently prioritized rule set groups by part priority within the subsequently prioritized rule set group, until the inventory storage capacity is reached.

2. The method of claim 1, wherein:
the received data characterizing a store further comprises at least one of:
vehicle population within a predetermined geographic area related to the store, and
parts sales data over the period for parts in the parts category; and
at least one received rule relates to at least one of:
vehicle population within a predetermined geographic area related to the store, and
parts sales data over the period for parts in the parts category.

3. The method of claim 1, wherein:
at least one received rule based at least in part on results of a predictive model, and
at least one received rule based at least in part on merchant knowledge.

4. A computer program product for identifying parts from a national inventory as parts for a future store-specific assortment, the computer program product comprising
a computer-readable medium; and
at least one module residing on the medium, and operable upon execution by a processor to:
receive data characterizing parts inventory storage capacity of a store for a part category for a future period;
receive data characterizing a plurality of parts in the part category;
receive a plurality of rules applicable to the part category;
assemble a plurality of rule sets, each rule set:
comprising at least one received rule, and
requiring compliance with each rule in the rule set for a part to be a member of the rule set group,
receive data prioritizing the assembled rule sets;
beginning with the highest priority rule set as the current rule set, and proceeding by order of rule set priority,
determine if each of the plurality of parts in the parts category is a member of the current rule set group;
for each of the plurality of parts in the parts category that is not a member of the current rule set group (i.e., remaining parts), determine if each of the remaining parts is a member of the next highest priority rule set group;
for each rule set group, receive data for prioritizing parts in a rule set group;
allocate parts to the assortment beginning with the highest prioritized part in the highest prioritized rule set group, and continue in order of part priority within a rule set group, then continue through subsequently prioritized rule set groups by part priority within the subsequently prioritized rule set group, until the inventory storage capacity is reached.

5. The method of claim 4, wherein:
the received data characterizing a store further comprises at least one of:
vehicle population within a predetermined geographic area related to the store, and
parts sales data over the period for parts in the parts category; and
at least one received rule relates to at least one of:
vehicle population within a predetermined geographic area related to the store, and
parts sales data over the period for parts in the parts category.

6. The method of claim 4, wherein:
at least one received rule based at least in part on results of a predictive model, and
at least one received rule based at least in part on merchant knowledge.
